(19) United States
(12) Patent Application Publication
(10) Pub. No.: US 2013/0057664 A1
(43) Pub. Date: Mar. 7, 2013

(54) CAMERA-BASED IMAGING DEVICES, HAVING ALTERNATING CLUSTERS OF LIGHT SOURCES, FACILITATED TO ELIMINATE HOT SPOTS

(71) Applicants: IUVAL HATZAV, CULVER CITY, CA (US); DANIEL HATZAV, HOD HASHARON (IL); ILAN BEN-SHAHAR, SAVION (IL); GIYORA SHARABY, MOSHAV NEVE YARAK (IL)

(72) Inventors: IUVAL HATZAV, CULVER CITY, CA (US); DANIEL HATZAV, HOD HASHARON (IL); ILAN BEN-SHAHAR, SAVION (IL); GIYORA SHARABY, MOSHAV NEVE YARAK (IL)

(73) Assignee: CSSN INC.

(21) Appl. No.: 13/223,342

(22) Filed: Sep. 1, 2011

(51) Int. Cl. H04N 7/18

(52) U.S. Cl. 348/61; 348/E05.024

(57) ABSTRACT

An imaging device for imaging a document including an enclosed imaging-optical-chamber, a processor, a camera mounted inside the imaging-optical-chamber, at least two clusters of light sources disposed inside the imaging-optical-chamber, for directly illuminating of the document, and a glass-window. The clusters of light sources are operated, one at a time, in a preconfigured sequence, and the camera is preconfigured to acquire an image frame of the document, operatively coupled with the activation of each of the clusters. The direct illumination causes formation of hotspots in the acquired image frames at preconfigured locations, corresponding to the preconfigured positioning of the clusters. The processor is facilitated to cutout the preconfigured image frame portions containing the hot spots, forming clean portions of the acquired image frame, and to combine the clean portions of acquired image frame to form an output image frame of the document.

### FIELD OF THE INVENTION

The present invention relates to illumination systems and methods for cameras, and more particularly to an illumination system and method facilitating a small-form camera-based imaging device for documents, wherein the imaged document is directly illuminated by alternating clusters of light sources.

### BACKGROUND OF THE INVENTION

There exist in today's market imaging devices capable of reading documents such as ID cards, drivers license, business cards, passports, medical cards and the like. In imaging devices that include an imaging sensor array, based on technologies such as a CCD or CMOS, it is required to illuminate the imaged document. It is desired that the illumination will be of high intensity and substantially uniform, in order to obtain a substantially true image of the imaged document.

The document is typical place on the surface of a substantially flat and substantially transparent panel, typically, with no limitation, made of glass (herein, also referred to as “glass-window”). But the glass surface and the imaged document are also a reflective surface, returning a portion of the incident light rays striking the transparent glass surface. Thereby, the image frame acquired from the imaged document is distorted. An internal light source that directly illuminates the glass-window bring are reflected from the glass surface, thereby forming “hot spots” that distort the uniformity of the illumination of the imaged document, and thereby causing the image of the imaged document not to be a substantially true image of the imaged document.

Reference is now made to FIG. 1a (Prior art) and to FIG. 1b (Prior art). FIG. 1b depicts a pair of hot spots 40 caused by direct illumination of the imaged document disposed on the external surface of a glass-window 20, as viewed from inside the camera housing. FIG. 1a illustrates how hot spots 40 are formed by direct illumination of the imaged document 10 disposed on the external surface of a glass-window 20. When imaging document 10 with a camera 50, document 10 needs to be illuminated. In a conventional illumination method, as shown in FIG. 1a, illumination sources 30a and 30b are positions to directly illuminate glass-window 20. Such configuration enables the return of the majority of light to the lens of camera 50, but gives rise to a hot spot 40, where the light source (30) itself is imaged by camera 50.

US patent application 20080285094, by Hatzav et al., provides a configuration method of the illumination system that reduces the hot spot problem, by disposing the light sources outside the field of view (FOV) of the camera. Reference is now made to FIG. 2 (Prior art), illustrating a pair of light sources 30 that are disposed outside the conventionally preconfigured FOV 60 of camera 50, which FOV 60 of camera 50 is denoted by virtual lines 62. Furthermore, the inner walls 55 and 75 of inner space 70 of the prior art document imaging device are white to further enhance the uniformity of the illumination. However, back-light (indirect) illumination brings about loss of light intensity and requires a high intensity light source. Furthermore, hot spots of lower intensity, with respect to direct illumination, still appeared in the image formed.

U.S. patent application Ser. No. 13/185,510, by Hatzav et al., provides a configuration method of the illumination system that reduces the hot spot problem, by disposing the light sources outside the field of view (FOV) of the camera. Reference is now made to FIG. 3 (Prior art), a schematic side view illustration of an imaging device 80, having light-occluding structures 88 disposed inside the housing 82 of imaging device 80 such that the imaginary light source 30′ of light sources 30 are situated outside the extended FOV 64 of camera 50, combined with mirrors 84 and reflective glass-window 20, which FOV 64 is denoted by virtual lines 66. Imaging device 80 does provide a small form imaging device having a substantially uniform illumination, but imaging device 80 is complex to manufacture and substantial illumination intensity is still lost before reaching camera 50.

Thus there is a need for and it would be advantageous to have a simple direct illumination and thereby inexpensive, small-form camera-based imaging device that has an illumination system that provides uniform illumination with no hot spot effects, as well as avoiding substantial loss of illumination intensity.

### SUMMARY OF THE INVENTION

In view of the limitations now presented in the prior art, the present invention provides a new, simple and useful imaging device for imaging documents that in effect, facilitates enhancement of the uniformity and intensity of the document illumination, utilizing an image sensor array and alternating clusters of light sources, disposed in preconfigured location inside the housing of the imaging device.

The term “cluster of light sources”, as used herein, refers to a single light source, composed of one or more light emitting devices, such as, with no limitation a LED light source, are activated or deactivated as a single unit. When activated, the cluster of light sources directly illuminates at least a portion of the imaged document, at a preconfigured illuminating angle.

The term “alternately operating” in relation to the operation of all clusters of light sources, as used herein, refers to the activation of all of the clusters of light sources, one at a time, in a preconfigured sequence.

It is then a principle intention of the present invention to provide an imaging device for imaging documents that has a small form and that includes a direct illumination system that provides an output image frame of the imaged document that contains substantially no hot spots.

The present invention is an improved imaging device for imaging documents, wherein the document is directly illuminated by at least two clusters of light sources, and wherein the output image frame does not contain hot spots formed as a result of the direct illumination of either of the at least two clusters of light sources.

Preferably, the imaging device includes an enclosed housing that prevents internal light from escaping the optical chamber of the imaging device, and more importantly, prevents external light from entering the optical chamber of the imaging device and possibly distorting the uniformity of the illumination.

According to the teachings of the present invention, there is provided an imaging device for imaging a document including an enclosed imaging-optical-chamber, a processor and at least one camera mounted inside the imaging-optical-chamber, wherein the camera is configured to acquire image frames of at least a portion of the document. The imaging device further includes a glass-window, wherein the document is operatively disposed on the external surface of the glass-window.

The imaging device further includes a light source configuration, disposed inside said enclosed imaging-optical-chamber, facilitated to directly illuminate the document from at least two illuminating angles. That is, each point in the document is illuminated from at least two different angles. Preferably, the imaging device includes at least two static clusters of light sources, for directly illuminating the portion of the document being imaged. Optionally, the imaging device includes a single cluster of light sources, disposed inside the enclosed imaging-optical-chamber, operatively coupled with a deflection mechanism for deflecting the light beams may be emitted from the cluster of light sources. The mechanism for deflecting the light beams operatively deflects the light beams to at least two preconfigured illuminating angles, wherein the camera is preconfigured to acquire an image frame of the document at each of the at least two illuminating angles.

The clusters of light sources are operated, one at a time, in a preconfigured sequence, and the camera is preconfigured to acquire an image frame of the portion of the document being imaged operatively coupled with the activation of each of the clusters of light sources. Since glass-window and the document are directly illuminated by the clusters of light sources, hotspots are formed in the acquired image frames at preconfigured locations, corresponding to the preconfigured positioning of the clusters of light sources.

The processor is facilitated to cutout the preconfigured image frame portions containing the hot spots, forming clean portions of the acquired image frame. The processor is also facilitated to combine the clean portions of acquired image frame to form an output image frame of the portion of the document. Thereby, obtaining an output image frame of the imaged document that contains substantially no hot spots.

Optionally, the document is an identity document.

Optionally, each individual light source of the light source configuration is selected from the group of light sources type: Infra Red (IR), Ultra Violate (UV), Visible Light (VL) and fluorescence image.

Optionally, each individual light source of the light source configuration is a LED light source.

Optionally, each individual light source of the light source configuration is a halogen light source.

Preferably, all walls of the optical chamber are opaque, except for the glass-window.

Preferably, all internal walls of the imaging-optical-chambers, except for the glass-windows, are painted in black.

An aspect of the present invention is to provide a method for imaging a document, including the steps of providing an imaging device as described hereabove, wherein the clusters of light sources are preconfigured to directly illuminating the portion of the document being imaged; wherein the clusters of light sources are preconfigured to alternately operate; and wherein the camera is preconfigured to acquire an image frame of the portion of the document being imaged operatively coupled with the activation of each of the clusters of light sources.

The method further includes performing alternately, one at a time, for all of the clusters of light sources, the steps of: a) activating a first cluster of the clusters of light sources to directly illuminating the document being imaged; b) acquiring an image frame of at least a portion of the document; c) deactivating the first cluster of light sources; and d) discarding a preconfigured portion of the acquired image frame, thereby forming a clean portion of the acquired image frame.

When the sequence of activated all clusters of light sources and obtaining a corresponding sequence of clean portion of the acquired image frame, the method further performs the step of combining the clean portions of the acquired image frame portions to form an output image frame of the portion of the document.

### BRIEF DESCRIPTION OF THE DRAWINGS

The present invention will become fully understood from the detailed description given herein below and the accompanying drawings, which are generally not drawn to scale and are given by way of illustration only and thus, not limitative of the present invention, and wherein:

FIG. 1a (prior art) illustrates the hot spot problem caused by direct illumination of the imaged document or external light sources;

FIG. 1b (prior art) depicts a hot spot caused by direct illumination of the imaged document and a substantially transparent window in front of the imaged document;

FIG. 2 (prior art) illustrates an indirect illumination configuration, as provided by some prior art document imaging devices;

FIG. 3 (prior art) is a schematic side view illustration of an imaging device, having light-occluding structures disposed inside the imaging device, such that the imaginary light sources are situated outside the extended FOV of camera, thereby providing a substantially uniform illumination.

FIG. 4 is a side view illustration of an imaging device having alternating clusters of light sources, according to embodiments of the present invention, wherein a side wall has been removed for illustration purposes only;

FIG. 5 is a perspective view illustration of the imaging device shown in FIG. 4, wherein a side wall has been removed for illustration purposes only;

FIG. 6 depicts an example document;

FIG. 7a depicts an image frame of the document shown in FIG. 6, acquired by the imaging device of the present invention, wherein 2 clusters of light sources were activated;

FIG. 7b depicts an image frame of the document shown in FIG. 6, acquired by the imaging device of the present invention, wherein a first cluster of light sources is activated;

FIG. 7c depicts an image frame of the document shown in FIG. 6, acquired by the imaging device of the present invention, wherein a second cluster of light sources is activated;

FIG. 7d depicts the output image frame of the document shown in FIG. 6, composed from portions of the image frames shown in FIGS. 7b and 7c;

FIG. 8 is a schematic flow chart showing an exemplary method of obtaining an output image frame that contains substantially no hot spot traces, according to embodiments of the present invention, utilizing a document imaging device as in FIG. 4.

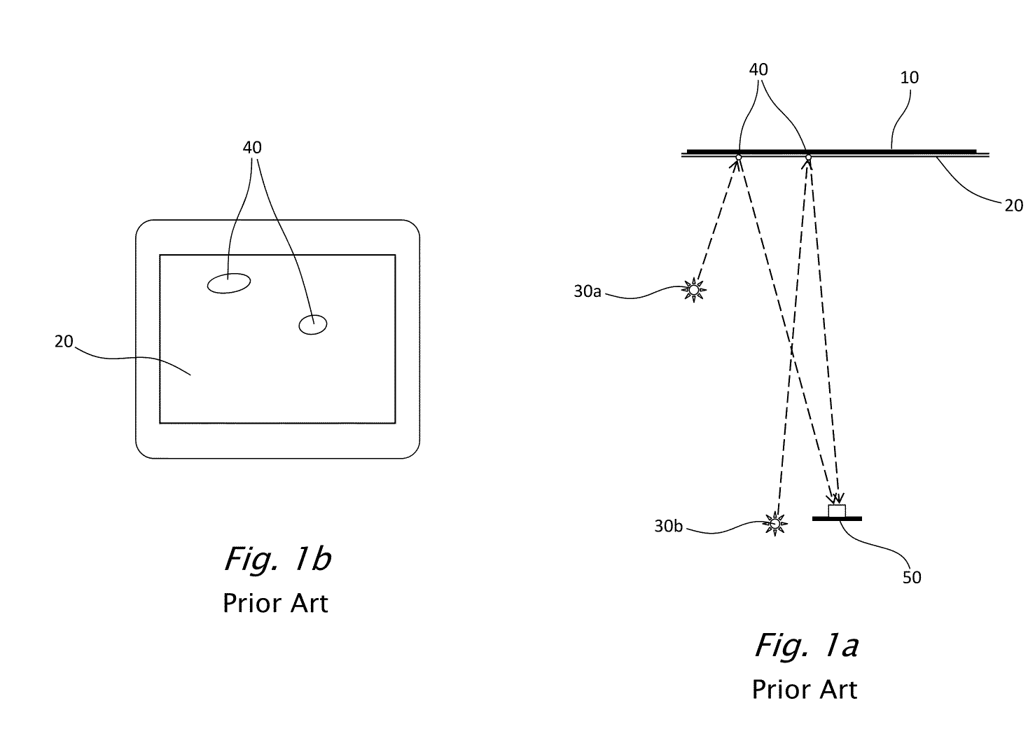

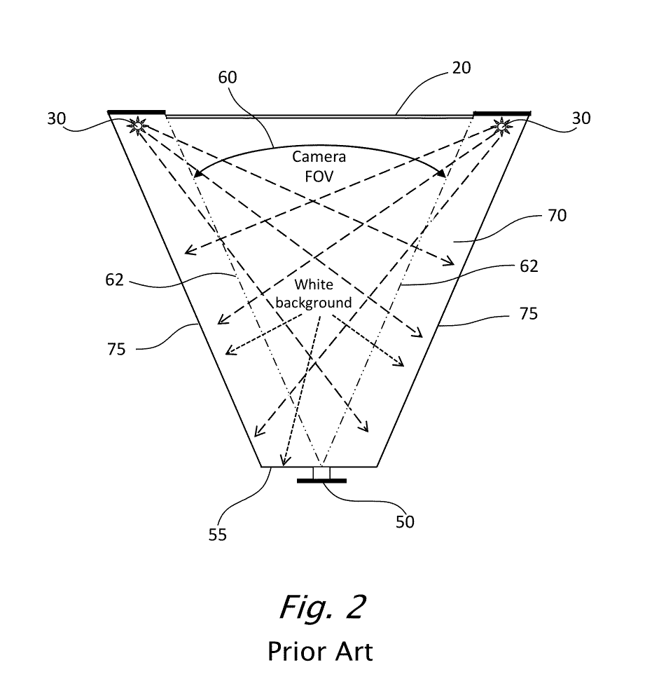

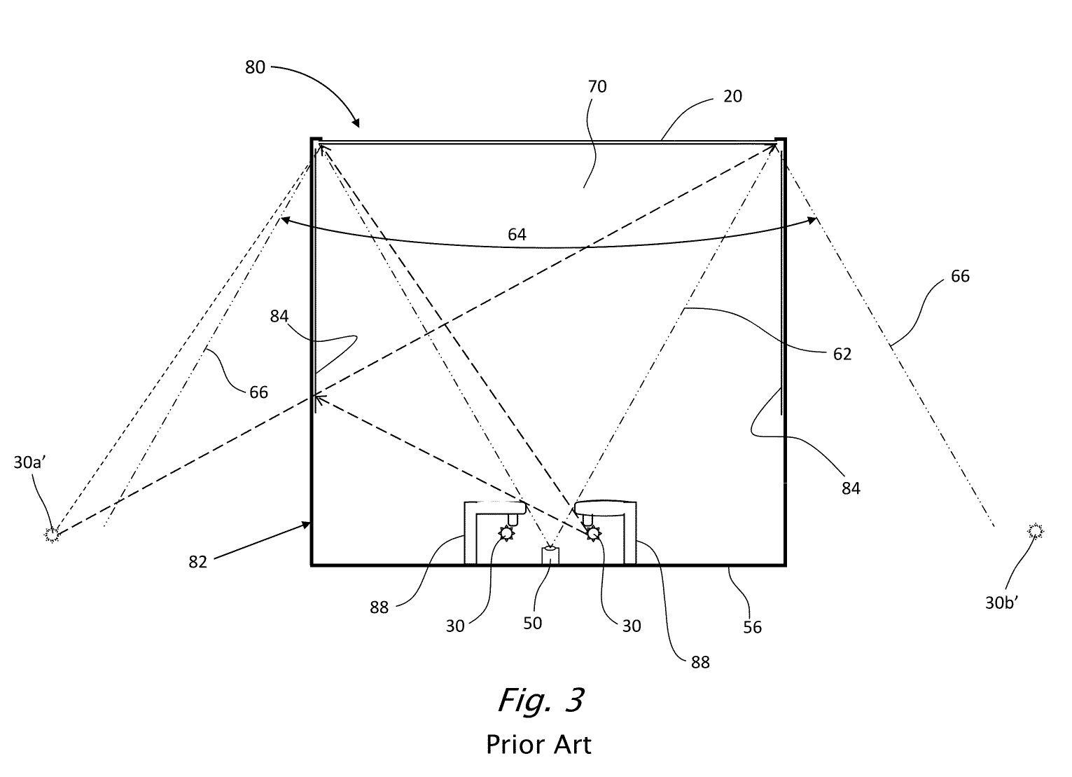

### DETAILED DESCRIPTION OF THE INVENTION

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

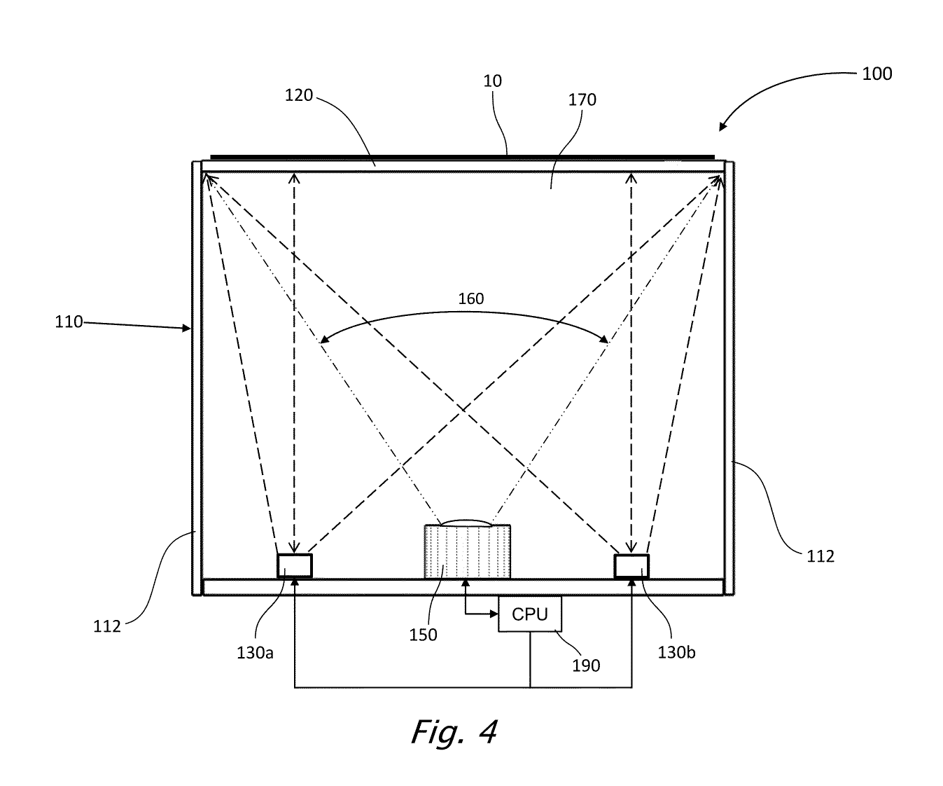

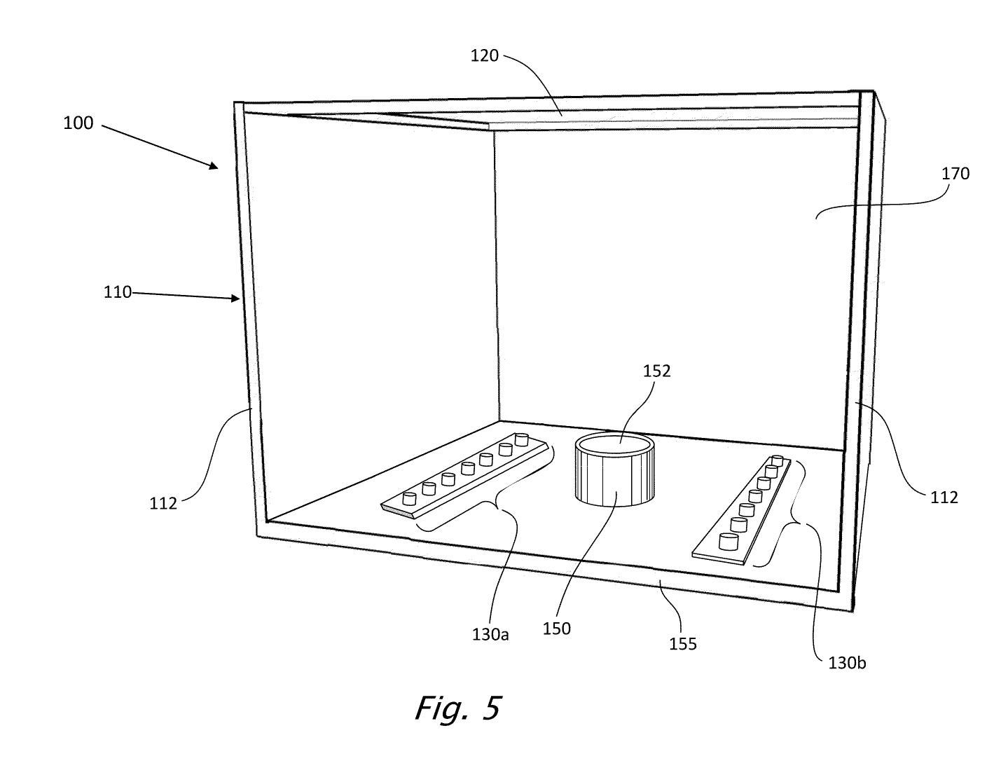

Reference is now made to FIG. 4, a side view illustration of an imaging device 100, according to embodiments of the present invention, wherein a side wall has been removed for illustration purposes only. Imaging device 100 includes a body 110 enclosing an imaging-optical-chamber 170, a camera 150, two or more clusters of light sources 130, a glass-window 120 and a processor 190. Reference is also made to FIG. 5, a perspective view illustration of imaging device 100. It should be noted that in FIGS. 4 and 5, a side wall has been removed for illustration purposes only.

Camera 150 is disposed on the internal surface of a camera wall 155 such that, preferably, the FOV 160 of lens 152 of camera 150 (also referred to as the FOV 160 of camera 150) views at least the whole of glass-window 120. Typically, camera wall 155 is disposed opposite to glass-window 120. Typically, clusters of light sources 130 are also disposed on the internal surface of camera wall 155 such that clusters of light sources 130 are not directly viewed by the FOV 160 of camera 150.

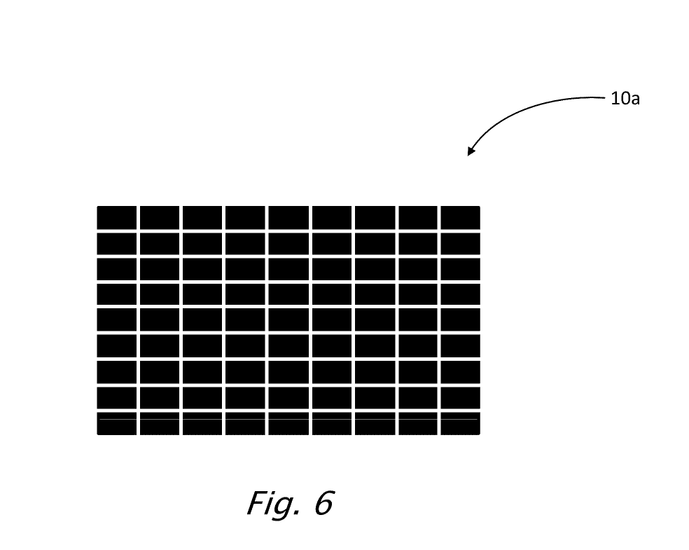

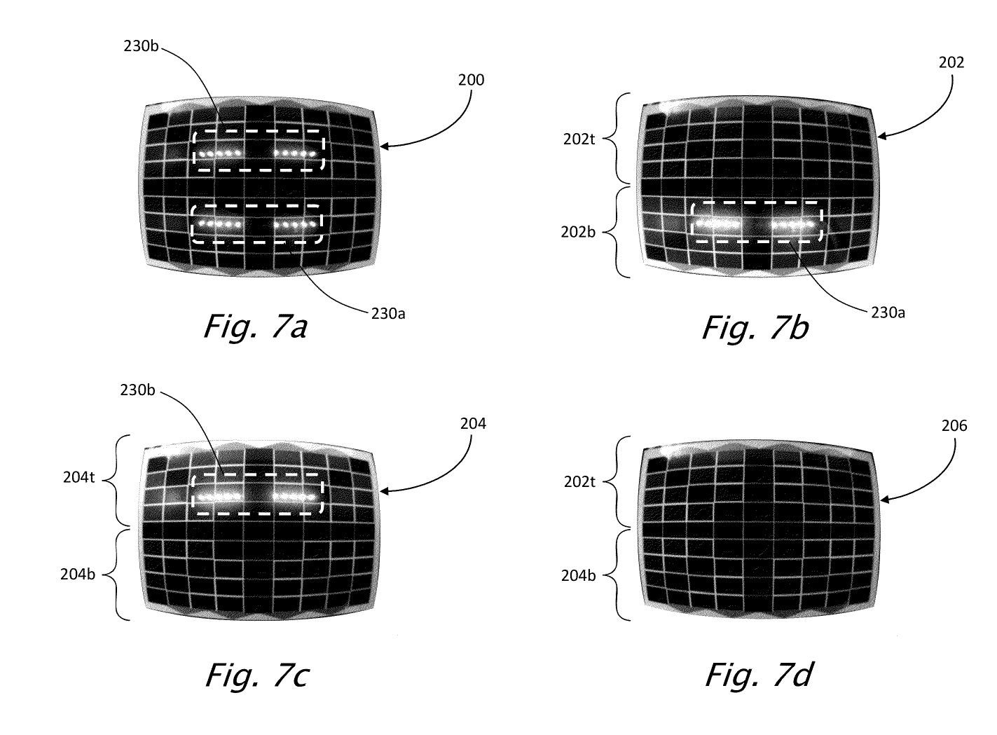

The operation of imaging device 100 is now explained through an example supported by FIGS. 6 and 7a-7d. FIG. 6 depicts an example document 10a, containing 9×9 rectangles arranged in a larger rectangle and separated by white gaps. FIG. 7a depicts an example image frame 200 of document 10a, acquired by imaging device 100, wherein two clusters of light sources, 130a and 130b, were activated, forming respective hot spots 230a and 230b. FIG. 7b depicts an example image frame 202 of document 10a, acquired by imaging device 100, wherein a first cluster of light sources 130a is activated, forming a respective hot spot 230a. FIG. 7c depicts an example image frame 204 of document 10a, acquired by imaging device 100, wherein a second cluster of light sources 130b is activated, forming a respective hot spot 230b. FIG. 7d depicts an example output image frame 206 of document 10a, composed from portions of the image frames 202 and 204. It should be noted that a cluster of light sources include one or more light source.

Referring now to FIG. 7a, image frame 200 of document 10a, the hot spot problem is illustrated. In this example, with no limitations, imaging device 100 includes two clusters of light sources 130a and 130b, both of which clusters of light sources are activated, as often done in conventional imaging devices. Image frame 200 of document 10a, acquired by imaging device 100, includes two hot spots 230a and 230b, formed respectively by the clusters of light sources 130a and 130b.

The method of the present invention is exemplified, with no limitations, in FIGS. 7b-7d. The two clusters of light sources 130a and 130b are alternately activated, at a preconfigured activation rate. When light source cluster 130a is ON, light source cluster 130b is OFF, and vice versa. Each image frame is subdivided, for example, into two sections, a top section and a bottom section, wherein “top” and “bottom” refer to the image frames (202, 204 and 206), as seen in FIGS. 7b-7c.

FIG. 7b depicts image frame 202 of document 10a, acquired when the first cluster of light sources 130a is ON (and the second cluster of light sources 130b is OFF), forming a respective cluster of hot spots 230a within the bottom section 202b of image frame 202. It should be noted that typically, cluster of light sources 130a is disposed on the internal surface of camera wall 155 at a preconfigured location, such that the corresponding cluster of hot spots 230a is formed within the bottom section 202b of image frame 202, with substantially no hot spot traces within the top section 202t of image frame 202.

Similarly, FIG. 7c depicts image frame 204 of document 10a, acquired when the second cluster of light sources 130b is ON (and the first cluster of light sources 130a is OFF), forming a respective cluster of hot spots 230b within the top section 204t of image frame 204. It should be noted that typically, cluster of light sources 130b is disposed on the internal surface of camera wall 155 at a preconfigured location, such that the corresponding cluster of hot spots 230b is formed within the top section 204t of image frame 204, with substantially no hot spot traces within the bottom section 204b of image frame 204.

The acquired image frames are stored in memory, operatively coupled with processor 190. Each pair of the acquired image frame, 202 and 204, includes an image frame section that is clean of hot spots formed by a cluster of light sources 130. In image frame 202 the top section 202t is clean of hot spots formed by a cluster of light sources 130, and in image frame 204 the bottom section 204b is clean of hot spots formed by a cluster of light sources 130. Processor 190 discards of the bottom section 202b image frame 202 and the top section 204t of image frame 204, and concatenates the top section 202t of image frame 202 onto the bottom section 204b image frame 204, thereby forming a new image frame 206. Image frame 206 contains substantially no hot spot traces that were originally formed image frames 202 and 204.

For the sake of clarity, light sources 130 may include any type of light source, preferably LED light sources, including IR, UV and visible light LED light sources or a combination thereof. Optionally, the light source is a halogen light source.

Florescence image of the document may be acquired by illuminating the document with excitation light in UV, NUV or blue wavelength and acquiring data from the green and red sensitive pixels of a color sensitive sensor array. An optical filter designed to block the excitation wavelength may be used to protect the sensor.

In variations of the present, the imaging device may include multiple clusters of light sources, each of which forms a hot spot cluster in the acquired image frame, when the cluster of light sources is activated. Any combination of clusters of light sources may be activated simultaneously, but not all of the clusters of light sources at once. Selected clusters of light sources are alternately activated, such that processor 190 forms a concatenated output image frame from a predetermined number of acquired image frames, such that the concatenated output image frame contains substantially no hot spot traces that were formed in the acquired image frames.

In variations of the present, the imaging device may include a single cluster of light sources, wherein the emitted light beams may be shifted or deflected by a deflection mechanism. The mechanism for deflecting the light beams operatively deflects the light beams to at least two preconfigured illuminating angles, wherein camera 150 is preconfigured to acquire an image frame of the document at each of the at least two illuminating angles.

The deflection mechanism can be, for example, a rotating prism may be placed in the path of the light beams. In another example, mirrors may be disposed on the inner side of side walls 112 of body 110 and the light cluster is rotatable to alternately illuminate one mirror, wherein the light beams deflect from the mirror the illuminate document 10. Image frames are acquired when illuminating either mirror, wherein the hotspots are respectively imaged at different location of the image frame.

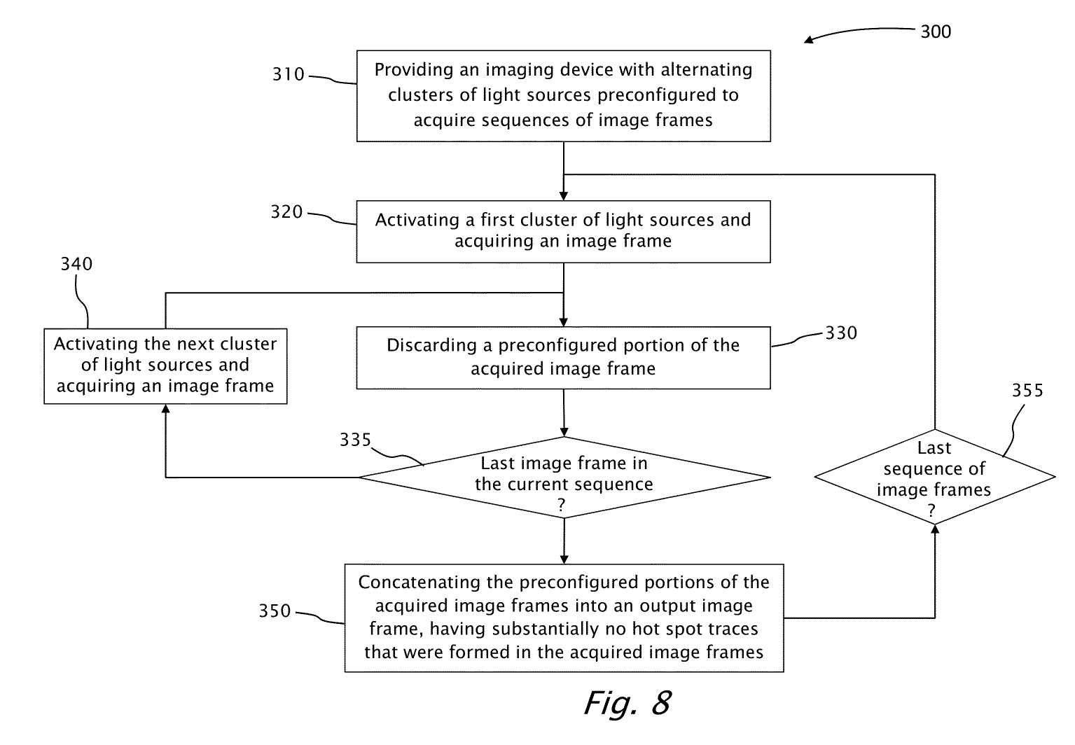

An exemplary method 300 of obtaining an output image frame that contains substantially no hot spot traces, in a document imaging device 100 having an imaging-optical-chamber 170, a camera 150, two or more clusters of light sources 130, a glass-window 120 and a processor 190, wherein the document is directly illuminate by clusters of light sources 130, through glass-window 120, is outlined in FIG. 8 and includes the following steps:

Step 310: activating imaging device 100 with alternating clusters of light sources 130 preconfigured to acquire sequences of image frames.
Imaging device 100 with alternating clusters of light sources 130 is preconfigured to acquire sequences of image frames, when a cluster of light sources 130 is turned ON (activated), while other clusters of light sources 130 are turned OFF (deactivated).
Typically, the length of a sequence of image frames corresponds to the number of different alternating clusters of light sources 130. In the example shown in FIGS. 7a-7d, the length of the sequence is typically 2.
   Step 320: activating a first cluster of light sources 130 and acquiring an image frame.
A first cluster of light sources 130 is turned ON and camera 150 acquires an image frame of document 10, while the other clusters of light sources 130 are kept OFF. For example, FIG. 7b depicts image frame 202 of document 10a, acquired when the first cluster of light sources 130a is turned ON, while the second cluster of light sources 130b is kept OFF. The acquired image frame 202 contains a cluster of hot spots 230a within the bottom section 202b of image frame 202, respective to the disposition of first cluster of light sources 130a inside imaging-optical-chamber 170.
   Step 330: discarding a preconfigured portion of the acquired image frame.
A preconfigured portion of the acquired image frame, containing the hot spots caused by the direct illumination of the cluster of light sources 130, is discarded.
In the example shown in FIGS. 7a-7d, after image frame 202 is acquired, the bottom section 202b of image frame 202 is discarded. After image frame 204 is acquired, the top section 204t of image frame 204 is discarded.
   Step 335: check if this is the last image frame in the sequence of image frames.
If last image frame in the current sequence has been acquired, go to step 350.
   Step 340: activating the next cluster of light sources 130 and acquiring an image frame.
The next cluster of light sources 130 is turned ON and camera 150 acquiring an image frame of document 10, while the other clusters of light sources 130 are kept OFF. For example, FIG. 7c depicts image frame 204 of document 10a, acquired when the second cluster of light sources 130b is turned ON, while the second cluster of light sources 130a is kept OFF. The acquired image frame 204 contains a cluster of hot spots 230b within the top section 202t of image frame 204, respective to the disposition of first cluster of light sources 130b inside imaging-optical-chamber 170.
Go step 330.
   Step 350: concatenating the preconfigured portions of the acquired image frames into an output image frames, having substantially no hot spot traces that were formed in the acquired image frames.
The preconfigured portions of the acquired image frames in a sequence, having substantially no hot spot traces that were formed in the acquired image frames, are concatenated in a preconfigured pattern, to thereby form an output image frame.
In the example shown in FIGS. 7a-7d, Processor 190 concatenates top section 202t of image frame 202 onto bottom section 204b image frame 204, thereby forming a new image frame 206. Image frame 206 contains substantially no hot spot traces that were originally formed image frames 202 and 204.
   Step 355: optionally, check if this is the last sequence of image frames.
Optionally, if this is not the last sequence of image frames, go to step 320.

In variations of the present, the imaging device may include two or more image sensors, such that the combined FOV of all image sensors covers a continuity of the glass-window (20) area.

Although the present invention has been described with reference to the preferred embodiment and examples thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the following claims.

What is claimed is:

1. An imaging device for imaging a document comprising:
(a) an enclosed imaging-optical-chamber;
(b) a processor;
(c) at least one camera mounted inside said imaging-optical-chamber;
(d) a light source configuration, disposed inside said enclosed imaging-optical-chamber, facilitated to directly illuminate the document from at least two illuminating angles; and
(e) a glass-window, wherein the document is operatively disposed on the external surface of said glass-window,
wherein said light source configuration includes at least one cluster of light sources, and wherein said clusters of light sources are operated, one at a time, in a preconfigured sequence;
wherein said camera is preconfigured to acquire an image frame of a portion of the document being imaged, and wherein said image acquisition is operatively coupled with the activation of each of said light sources at each of said at least two illuminating angles;
wherein hotspots are formed in said acquire an image frames at preconfigured locations;
wherein said processor is facilitated to cutout said preconfigured image frame portions containing said hot spots, forming clean portions of said acquired image frame portions; and
wherein said processor is facilitated to combine said clean portions of acquired image frame to form an output image frame of said portion of the document.

2. The imaging device as in claim 1, wherein said light source configuration comprises at least two clusters of light sources.

3. The imaging device as in claim 1, wherein the document is an identity document.

4. The imaging device as in claim 1, wherein each individual light source of said light source configuration is selected from the group of types of light sources including Infra Red (IR), Ultra Violate (UV) and Visible Light (VL).

5. The imaging device as in claim 1, wherein each individual light source of said light source configuration is a LED light source.

6. The imaging device as in claim 1, wherein each individual light source of said light source configuration is a halogen light source or fluorescence image.

7. The imaging device as in claim 1, wherein all walls of said optical chamber are opaque, except for said glass-window.

8. The imaging device as in claim 1, wherein all internal walls of said imaging-optical-chambers, except for said glass-windows, are painted in black.

9. The imaging device as in claim 1, wherein said light source configuration comprises a cluster of light sources and a mechanism for deflecting the light beams emitted from said light sources, wherein said mechanism for operatively deflecting said light beams to said at least two illuminating angles.

10. A method for imaging a document, comprising the steps of:
(a) providing an imaging device including:
i. an enclosed imaging-optical-chamber;
ii. a processor;
iii. at least one camera mounted inside said imaging-optical-chamber, wherein said camera is configured to acquire image frames of at least a portion of the document;
iv. at least two clusters of light sources, disposed inside said enclosed imaging-optical-chamber, for directly illuminating said portion of the document being imaged; and
v. a glass-window, wherein the document is operatively disposed on the external surface of said glass-window,
wherein said clusters of light sources are preconfigured to alternately operate; and
wherein said camera is preconfigured to acquire an image frame of said portion of the document being imaged operatively coupled with the activation of each of said clusters of light sources;
(b) alternately, for all of said clusters of light sources, perform the following steps:
i. activating a first cluster of said clusters of light sources to directly illuminating the document being imaged;
ii. acquiring an image frame of at least a portion of the document;
iii. deactivating said first cluster of light sources; and
iv. discarding a preconfigured portion of said acquired image frame, thereby forming a clean portion of said acquired image frame; and
(c) combining said clean portions of said acquired image frame portions to form an output image frame of said portion of the document.

11. The method as in claim 10, wherein the document is an identity document.

12. The method as in claim 10, wherein each individual light source of said clusters of light sources is selected from the group of types of light sources including Infra Red (IR), Ultra Violate (UV) and Visible Light (VL).

13. The method as in claim 10, wherein each individual light source of said clusters of light sources is a LED light source.

14. The method as in claim 10, wherein each individual light source of said clusters of light sources is a halogen light source or a fluorescence image.

15. The method as in claim 10, wherein all walls of said optical chamber are opaque, except for said glass-window.

16. The method as in claim 10, wherein all internal walls of said imaging-optical-chambers, except for said glass-windows, are painted in black.
